(19) United States
(12) Patent Application Publication
(10) Pub. No.: US 2022/0050629 A1
(43) Pub. Date: Feb. 17, 2022

(54) COMPLETION MANAGEMENT

(71) Applicant: Micron Technology, Inc., Boise, ID (US)

(72) Inventors: Aleksei Vlasov, Austin, TX (US); Scheheresade Virani, Frisco, TX (US); Yoav Weinberg, Thornhill (CA); Prateek Sharma, San Jose, CA (US); Venkat R. Gaddam, Fremont, CA (US)

(21) Appl. No.: 16/992,164

(22) Filed: Aug. 13, 2020

(51) Int. Cl. G06F 3/06; G06F 9/46

(52) U.S. Cl. CPC G06F 3/0659; G06F 3/0656; G06F 3/0653; G06F 9/466; G06F 3/0604; G06F 3/0673; G06F 3/0629

(57) ABSTRACT

A system includes a storage system and circuitry coupled to the storage system. The circuitry is configured to perform operations comprising attempting a communication of a first completion associated with a first transaction processed by the storage system. The operations further comprise, responsive to failure of the communication of the first completion, storing the first completion in a local memory of the storage system and subsequently attempting a communication of the first completion from the local memory.

### TECHNICAL FIELD

Embodiments of the disclosure relate generally to storage systems, and more specifically, relate to completion management.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a storage system in accordance with some embodiments of the present disclosure.

FIG. 2 illustrates an example of a storage system controller and in accordance with some embodiments of the present disclosure.

FIGS. 3A-3B illustrate an example of a host interface in accordance with some embodiments of the present disclosure.

FIG. 4 is a flow diagram corresponding to a method for performing completion management in accordance with some embodiments of the present disclosure.

FIG. 5 is a block diagram of an example computer system in which embodiments of the present disclosure can operate.

### DETAILED DESCRIPTION

Aspects of the present disclosure are directed to completion management associated with a storage system. An example of a storage system is a solid-state drive (SSD). An SSD can include multiple interface connections to one or more host systems. The interface connections can be referred to as ports. A host system can send protocol-based commands to the SSD via a port. Protocol-based commands received by the SSD can be translated into data commands (e.g., read, write, erase, program, etc.). In general, a host system can utilize a storage system that includes one or more memory components (also hereinafter referred to as “memory devices”). The host system can provide data to be stored at the storage system and can request data to be retrieved from the storage system.

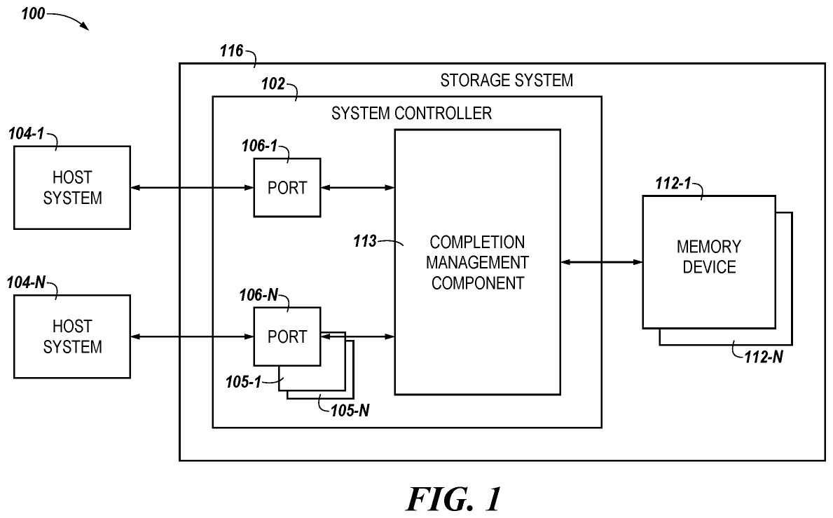

A memory device can be a non-volatile memory device. One example of a non-volatile memory device is a three-dimensional cross-point memory device that includes a cross-point array of non-volatile memory cells. Other examples of non-volatile memory devices are described below in conjunction with FIG. 1. A non-volatile memory device, such as a three-dimensional cross-point memory device, can be a package of one or more memory components (e.g., memory dice). Each die can consist of one or more planes. Planes can be grouped into logic units. For example, a non-volatile memory device can be assembled from multiple memory dice, which can each form a constituent portion of the memory device.

A memory device can be a non-volatile memory device. One example of non-volatile memory devices is a negative-and (NAND) memory device (also known as flash technology). Other examples of non-volatile memory devices are described below in conjunction with FIG. 1. A non-volatile memory device is a package of one or more dice. Each die can consist of one or more planes. Planes can be groups into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A block hereinafter refers to a unit of the memory device used to store data and can include a group of memory cells, a word line group, a word line, or individual memory cells. For some memory devices, blocks (also hereinafter referred to as “memory blocks”) are the smallest area than can be erased. Pages cannot be erased individually, and only whole blocks can be erased.

Each of the memory devices can include one or more arrays of memory cells. Depending on the cell type, a cell can store one or more bits of binary information, and has various logic states that correlate to the number of bits being stored. The logic states can be represented by binary values, such as “0” and “1”, or combinations of such values. There are various types of cells, such as single level cells (SLCs), multi-level cells (MLCs), triple level cells (TLCs), and quad-level cells (QLCs). For example, a SLC can store one bit of information and has two logic states.

Some NAND memory devices employ a floating-gate architecture in which memory accesses are controlled based on a relative voltage change between the bit line and the word lines. Other examples of NAND memory devices can employ a replacement-gate architecture that can include the use of word line layouts that can allow for charges corresponding to data values to be trapped within memory cells based on properties of the materials used to construct the word lines.

Transactions or commands, such as read commands or write commands, can be communicated to a storage system from a component or element coupled thereto. When the storage system has processed a transaction or command to completion, the storage system can generate an indication of completion of the transaction or command. Hereinafter, an indication of completion of a transaction or command is referred to as a “completion.” The storage system can communicate a data packet including a completion, such as a completion transaction layer packet (completion TLP), to a component external to the storage system. Hereinafter, such a data packet is referred to as a “completion data packet.” A completion can be placed in a submission queue prior to communicating the completion to the component or element that issued the transaction or command to which the completion corresponds. As used herein, a “submission queue” refers to a memory component of a storage system configured to store a completion and/or a completion data packet prior to communicating the completion and/or completion data packet to the component or element that issued the transaction or command to which the completion corresponds. A non-limiting example of a submission queue can be a register. The register can be a first in, first out (FIFO) register. A storage system can include one or more submission queues. For example, a multi-function storage system can include a submission queue associated with at least one function of the multi-function storage system. A submission queue can be shared by multiple functions of a storage system. Non-limiting examples of functions include physical functions and virtual functions (VFs). A storage system can send and/or receive data via a physical function and/or a VF as described herein.

Although a storage system can include multiple submission queues, a component (e.g., a physical component, such as a host system, and/or a virtual component, such as a virtual machine) to which a completion is to be communicated can include a single completion queue. As used herein, a “completion queue” refers to a memory component of a component coupled to a storage system configured to store a completion and/or a completion data packet received from the storage system. When communicating a completion and/or a completion data packet from a submission queue of a storage system to a completion queue of a component coupled to the storage system, the completion queue can be full (e.g., have insufficient storage capacity) such that the completion queue cannot receive the completion.

Some previous approaches to handling a failed attempt to communicate a completion and/or a completion data packet due to a completion queue being full can include a storage system including firmware configured to maintain an indication of a transaction or command to which the completion corresponds. The storage system can also include an allocation of memory to store the completions until another attempt to communicate the completion and/or the completion data packet is made. The storage system can also include firmware configured to evaluate the status of the completion queue and attempt to communicate the completion again according to a scheduling algorithm. The scheduling algorithm can maintain an order of the completions. For example, a storage system can receive a first transaction from a host system coupled thereto. Subsequently, the storage system can receive a second transaction. Communication of a first completion associated with the first transaction from the storage system to the host system can be unsuccessful. The firmware would have to ensure that the first completion is successfully communicated to the host system prior attempting to communicate a second completion associated with the second transaction because the host system would expect to receive the first completion prior to receiving the second completion. Implementing firmware on a storage system to manage communications of completions as described above can be complex. Implementation of such firmware on a multi-function storage system can be even more complex to management of communication of completions associated with multiple functions.

Aspects of the present disclosure address the above and other deficiencies by including circuitry configured to manage communication of completions and/or completion data packets from the storage system. The circuitry can be configured to store a completion and/or a completion data packet in a local memory of the storage system in response to unsuccessful communication of the completion and/or the completion data packet. Attempting to communicate a completion or a completion data packet can include determining whether a completion queue has sufficient storage for the completion and/or completion data packet. For instance, the circuitry can be configured to store a completion and/or a completion data packet in a local memory of the storage system in response to determining that the completion queue has insufficient storage for the completion and/or completion data packet. As described herein, whether a completion queue has sufficient storage for a completion and/or a completion data packet can be determined using head and tail pointers of the completion queue. In some embodiments, the circuitry can include hardware logic to determine if the completion queue has sufficient storage available for the completion and/or the completion data packet.

The local memory can be a register, such as a FIFO register. Such a FIFO register can be referred to as a “retry FIFO” in reference to the FIFO register being used to retry communication of a completion and/or a completion data packet following an unsuccessful communication of the completion and/or the completion data packet. The circuitry can be configured to communicate the completion and/or the completion data packet from the local memory to the completion queue. The circuitry can be configured to, in response to an unsuccessful communication of the completion and/or the completion data packet from the local memory to the completion queue, store the completion in the local memory. The circuitry can be notified of storage of the completion queue being available for the completion and/or completion data packet via a host notification to a completion queue tail doorbell register. Doorbell registers are discussed further herein. If the completion queue has insufficient storage and the completion and/or completion data packet is stored in the local memory, then the retry mechanism is engaged when the host performs a doorbell ring. This can be indicative of another completion and/or completion data packet being communicated (e.g., removed) from the completion queue.

In some embodiments, the circuitry can include hardware logic to determine an order at which to communicate completions and/or completion data packets from the local memory. For example, the hardware logic can be configured to determine an indication of a transaction to which a completion corresponds to ensure that completions are communicated from the storage system to the completion queue in an order of the transactions to which the completions correspond.

Embodiments of the present disclosure can reduce complexity of firmware of a storage system, particularly of a multi-function storage system. Embodiments of the present disclosure can enable management of completion queues of a host system coupled to a storage system by the storage system rather than by the host system. Unlike firmware, hardware of a storage system can utilize a doorbell signal as a trigger. As used herein, a “doorbell signal” refers to a signal issued when a completion has been transferred to a submission queue. In some embodiments, a doorbell signal can be used as a trigger to attempt communication of a completion and/or determine whether a completion queue is full. Embodiments of the present disclosure can prevent firmware issues when a completion queue is full. For example, firmware can process other transactions or commands when the completion queue is full.

FIG. 1 illustrates an example computing system 100 that includes a storage device, in accordance with some embodiments of the present disclosure. In at least one embodiment of the storage system 116 is an SSD. The computing system 100 can include one or more host systems (e.g., the host system 104-1, . . . , the host system 104-N). The host system 104-1, . . . , the host system 104-N can be referred to collectively as the host systems 104. The host systems 104 can be a computing device such as a desktop computer, laptop computer, network server, mobile device, or such computing device that includes a memory and a processing device. The host systems 104 can include or be coupled to the storage system 116. The host systems 104 can write data to the storage system 116 and/or read data from the storage system 116. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The storage system 116 can include memory devices 112-1 to 112-N (referred to collectively as the memory devices 112). The memory devices 112 can include any combination of the different types of non-volatile memory devices and/or volatile memory devices. Some examples of volatile memory devices include, but are not limited to, random access memory (RAM), such as dynamic random access memory (DRAM) and synchronous dynamic random access memory (SDRAM). Some examples of non-volatile memory devices include, but are not limited to, negative-and (NAND) type flash memory and write-in-place memory, such as a three-dimensional cross-point (“3D cross-point”) memory device. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased.

Each of the memory devices 112 can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each of the memory devices 112 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory devices 112 can be grouped as pages that can refer to a logical unit of the memory device used to store data. With some types of memory (e.g., NAND), pages can be grouped to form blocks.

Although non-volatile memory components such as 3D cross-point are described, the memory device 112 can be based on any other type of non-volatile memory or storage device, such as negative-and (NAND), read-only memory (ROM), phase change memory (PCM), self-selecting memory, other chalcogenide based memories, ferroelectric random access memory (FeRAM), magneto random access memory (MRAM), negative-or (NOR) flash memory, and electrically erasable programmable read-only memory (EEPROM).

The host systems 104 can be coupled to the storage system 116 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a dual in-line memory module (DIMM) interface (e.g., DIMM socket interface that supports Double Data Rate (DDR)), etc. The physical host interface can be used to transmit data between the host systems 104 and the storage system 116. The host systems 104 can further utilize an NVM Express (NVMe) interface to access the memory devices 112 when the storage system 116 is coupled with the host systems 104 by the PCIe interface. The physical host interface can provide an interface for passing control, address, data, and other signals between the storage system 116 and the host systems 104.

The host systems 104 can send one or more commands (e.g., read, write, erase, program, etc.) to the storage system 116 via one or more ports (e.g., the port 106-1, . . . , the port 106-N) of the storage system 116. The port 106-1, . . . , the port 106-N can be referred to collectively as the ports 106. As used herein, a “port” can be a physical port or a virtual port. A physical port can be a port configured to send and/or receive data via a physical function. A virtual port can be a port configured to send and/or receive data via a virtual function (VF). The ports 106 of the storage device 116 can communicatively couple the storage system 116 to the host systems 104 via a communication link (e.g., a cable, bus, etc.) to establish a respective command path to a respective one of the host systems 104.

The storage system 116 can be capable of pipelined command execution in which multiple commands are executed, in parallel, on the storage system 116. The storage system 116 can have multiple command paths to the memory devices 112. For example, the storage system 116 can be a multi-channel and/or multi-function storage device that includes multiple physical PCIe paths to the memory devices 112. In another example, the storage system 116 can use single root input/output virtualization (SR-IOV) with multiple VFs that act as multiple logical paths to the memory devices 112.

SR-IOV is a specification that enables the efficient sharing of PCIe devices among virtual machines. A single physical PCIe can be shared on a virtual environment using the SR-IOV specification. For example, the storage system 116 can be a PCIe device that is SR-IOV-enabled and can appear as multiple, separate physical devices, each with its own PCIe configuration space. With SR-IOV, a single IO resource, which is referred to as a physical function, can be shared by many VMs. An SR-IOV virtual function is a PCI function that is associated with an SR-IOV physical function. A VF is a lightweight PCIe function that shares one or more physical resources with the physical function and with other VFs that are associated with that physical function. Each SR-IOV device can have a physical function and each physical function can have one or more VFs associated with it. The VFs are created by the physical function.

In some embodiments, the storage system 116 includes multiple physical paths and/or multiple VFs that provide access to a same storage medium (e.g., one or more of the memory devices 112) of the storage system 116. In some embodiments, at least one of the ports 106 can be PCIe ports.

In some embodiments, the computing system 100 supports SR-IOV via one or more of the ports 106. In some embodiments, the ports 106 are physical ports configured to transfer data via a physical function (e.g., a PCIe physical function). In some embodiments, the storage system 116 can include virtual ports 105-1, . . . , 105-N (referred to collectively as the virtual ports 105). The virtual ports 105 can be configured to transfer data via a VF (e.g., a PCIe VF). For instance, a single physical PCIe function (e.g., the port 106-N) can be virtualized to support multiple virtual components (e.g., virtual ports such as the virtual ports 105) that can send and/or receive data via respective VFs (e.g., over one or more physical channels which can each be associated with one or more VFs). In some embodiments, the storage system 116 is a resource of a VM.

The storage system 116 can be configured to support multiple connections to, for example, allow for multiple hosts (e.g., the host systems 104) to be connected to the storage system 116. As an example, in some embodiments, the computing system 100 can be deployed in environments in which one or more of the host systems 104 are located in geophysically disparate locations, such as in a software defined data center deployment. For example, the host system 104-1 can be in one physical location (e.g., in a first geophysical region), the host system 104-N can be in a second physical location (e.g., in a second geophysical region), and/or the storage system 116 can be in a third physical location (e.g., in a third geophysical region).

The storage system 116 can include a system controller 102 to communicate with the memory devices 112 to perform operations such as reading data, writing data, or erasing data at the memory devices 112 and other such operations. The system controller 102 can include hardware such as one or more integrated circuits and/or discrete components, a buffer memory, or a combination thereof. The hardware can include digital circuitry with dedicated (i.e., hard-coded) logic to perform the operations described herein. The system controller 102 can be a microcontroller, special purpose logic circuitry (e.g., a field programmable gate array (FPGA), an application specific integrated circuit (ASIC), etc.), or other suitable processor. In general, the system controller 102 can receive commands or operations from any one of the host systems 104 and can convert the commands or operations into instructions or appropriate commands to achieve the desired access to the memory devices 112. The system controller 102 can be responsible for other operations such as wear leveling operations, garbage collection operations, error detection and error-correcting code (ECC) operations, encryption operations, caching operations, and address translations between a logical block address and a physical block address that are associated with the memory devices 112.

The storage system 116 can include a completion management component 113. The completion management component 113 can be configured to attempt to communicate a first completion associated with a first transaction processed by the storage system 116 to a component external to the storage system 116. The first completion can be included in a first completion data packet. The completion management component 113 can be configured to, responsive to failure to communicate the first completion, store the first completion in a local memory of the storage system 116 and subsequently attempt a communication of the first completion from the local memory. The completion management component 113 can be further configured to, responsive to failure to communicate the first completion from the local memory, transfer the first completion to the local memory and subsequently attempt to communicate the first completion from the local memory to the component external to the storage system.

The completion management component 113 can be configured to attempt to communicate a second completion associated with a second transaction processed by the storage system 116 to the component external to the storage system or another component external to the storage system. The second completion can be included in a second completion data packet. The completion management component 113 can be configured to, responsive to failure to communicate the second completion, store the second completion in the local memory to the component external to the storage system or the other component external to the storage system and subsequently attempt to communicate the second completion from the local memory to the component external to the storage system or the other component external to the storage system. The completion management component 113 can be configured to maintain an order of processing of the first transaction and the second transaction and attempt communication of the first completion and the second completion from the local memory to the component external to the storage system or the other component external to the storage system according to the order. The first transaction can be processed by the storage system 116 prior to the second transaction. The completion management component 113 can be configured to attempt communication of the first completion from the local memory to the component external to the storage system prior to attempting communication of the second completion from the local memory to the component external to the storage system or the other component external to the storage system.

In some embodiments, the completion management component 113 can be configured to determine whether an initial communication of a completion, associated with a transaction processed by the storage system 116, from the storage system 116 to one or more of the host systems 104 is successful. Communication of the completion can be achieved via communication of a completion data packet including the completion. At least one of the host systems 104 can include a completion queue. The completion management component 113 can be configured to store the completion in a register of the storage system 116 and attempt to communicate the completion from the register to one or more of the host systems 104 in response to determining that the initial communication of the completion was unsuccessful. The register can be a FIFO register. In some embodiments, the completion management component 113 can be configured to determine whether the initial communication of the completion is successful without interaction of firmware of the storage system 116. The completion management component 113 can be configured to attempt to communicate the completion from the register in a round robin manner.

In some embodiments, the storage system 116 can include one or more submission queues and hardware logic circuitry. The completion management component 113 can include the submission queues and/or the hardware logic circuitry. The system controller 102 can include the hardware logic circuitry. The hardware logic circuitry can be configured to retrieve a completion from one of the submission queues and retrieve another completion from another one of the submission queues. The hardware logic circuitry can be configured to responsive to the determination being that the submission queue is full, store the completion in a register of the storage system.

In some embodiments, the hardware logic circuitry can be configured to determine whether the completion queue is full by maintaining a head pointer and a tail pointer of the completion queue maintained in memory of at least one of the host systems 104, updating the tail pointer in response to a completion being transferred to the completion queue, and determining that the completion queue is full in response to a value of the tail pointer being at least the storage capacity of the completion queue. A storage capacity of the register can correspond to a storage capacity of the completion queue such that if the value of the tail pointer is greater than or equal to the storage capacity of the completion queue, then the completion queue is full and cannot store another completion. Because the hardware logic circuity manages communication of completions, after firmware of the storage system 116 communicates a completion to the hardware logic circuitry, the firmware has no further involvement with (e.g., performs no other operations in association with) communication of the completion. Furthermore, because the storage capacity of the register can correspond to a storage capacity of the completion queue, the storage system 116 can determine whether the completion queue is full without interacting or interrogating the completion queue or a component or element on which the completion queue is implemented (e.g., without interacting or interrogating a corresponding one of the host systems 104).

The hardware logic circuitry can be configured to, subsequent to storing the first completion in the register, perform a second determination whether the submission queue is full. The hardware logic circuitry can be configured to transfer the first completion from the register to the completion queue in response to the second determination being that the submission queue is not full. The hardware logic circuitry can be configured to store the first completion in the register in response to the second determination being that the completion queue is full. The hardware logic circuitry can be configured to retrieve the first completion from the first one of the submission queues in response to signaling indicative of the first completion transferred to the first one of the submission queues.

The hardware logic circuitry can be configured to retrieve a second completion from a second one of the completion queues and perform a determination whether the submission queue is full. The hardware logic circuitry can be configured to store the second completion in the register in response to determining that the submission queue is full and transfer the second completion from the register to the completion queue in response to determining that the completion queue is not full.

In some embodiments, a first completion can be retrieved from a submission queue of the storage system 116 in response to a first doorbell signal. Whether a submission queue of one of the host systems 104 can receive the first completion can be determined. The first completion can be transferred to a FIFO register of the storage system 116 in response to determining that the submission queue cannot receive the first completion. Subsequent to transferring the first completion to the FIFO register and determining whether the completion queue can receive the first completion, the first completion can be transferred from the FIFO register to the completion queue in response to determining that the completion queue can receive the first completion. Subsequent to the first doorbell signal and responsive to a second doorbell signal, a second completion can be retrieved from the submission queue. Whether the completion queue can receive the second completion can be determined and, responsive to determining that the completion queue cannot receive the second completion, the second completion can be transferred to the FIFO register. The first completion can be transferred to a first allocation of the FIFO register and the second completion can be transferred to a second allocation of the FIFO register in response to determining that the completion queue cannot receive the first completion and the second completion. Subsequent to transferring the first completion to the first allocation and the second completion to the second allocation, whether the completion queue can receive the first completion can be determined. The first completion can be transferred from the FIFO register to the completion queue in responsive to determining that the completion queue can receive the first completion. Subsequently whether the completion queue can receive the second completion can be determined. The second completion can be transferred from the FIFO register to the completion queue in response to determining that the completion queue can receive the second completion. The second completion can be transferred to the FIFO register in response to determining that the completion queue cannot receive the second completion. Subsequent to transferring the second completion to the FIFO register, determining whether the completion queue can receive the second completion. The second completion can be transferred from the FIFO register to the completion queue in response to determining that the completion queue can receive the second completion. The second completion can be transferred to the FIFO register in response to determining that the completion queue cannot receive the second completion.

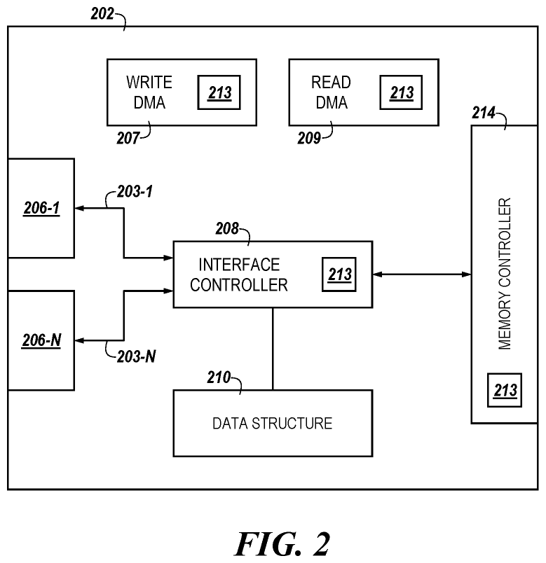

FIG. 2 illustrates an example of a system controller 202 in accordance with some embodiments of the present disclosure. The system controller 202 can be analogous to the system controller 102 illustrated by FIG. 1. The system controller 202 can include a memory controller 214 to control operation of memory devices of a storage system, such as the memory devices 112 of the storage system 116 illustrated by FIG. 1. In some embodiments, the memory controller 214 is a flash memory controller, such as a NAND flash controller, or other suitable controller and media.

The system controller 202 can include an interface controller 208, which is communicatively coupled to one or more of port 206-1, . . . , port 206-N. The port 206-1, . . . , port 206-N can be referred to collectively as the ports 206 and analogous to the ports 106 illustrated by FIG. 1. The interface controller 208 can control movement of commands and/or data between one or more host systems, such as the host systems 104 illustrated by FIG. 1, and the memory controller 214. For instance, the interface controller 208 can process commands transferred between the host systems and the memory devices of the storage system via the memory controller 214. In some embodiments, the interface controller 208 is a NVMe controller. For example, the interface controller 208 can operate in accordance with a logical device interface specification (e.g., protocol), such as the NVMe specification or a non-volatile memory host controller interface specification. Accordingly, in some embodiments, the interface controller 208 can process commands according to the NVMe protocol.

The interface controller 208 can be coupled to the ports 206 via respective command paths (e.g., command path 203-1, . . . , command path 203-N). The command path 203-1, . . ., the command path 203-N can be referred to collectively as the command paths 203. The command paths 203 can include physical paths (e.g., a wire or wires) that can be configured to pass physical functions and/or VFs between a respective one of the ports 206 and the interface controller 208. The command paths 203 can be configured to pass physical functions and/or VFs between a respective one of the ports 206 and the interface controller 208 in accordance with the NVMe standard. For example, in an SR-IOV deployment, the interface controller 208 can serve as multiple controllers (e.g., multiple NVMe controllers) for respective physical functions and/or each VF, such that the interface controller 208 provides multiple controller operations.

The interface controller 208 can be coupled to a data structure 210. As used herein, a “data structure” refers to a specialized format for organizing and/or storing data, which can be organized in rows and columns; however, embodiments of the present disclosure are not so limited. Examples of data structures include arrays, files, records, tables, trees, etc.

Although FIG. 2 illustrates a single interface controller 208, embodiments are not so limited. For instance, the interface controller 208 can comprise multiple sub-controllers and/or multiple controllers. For example, each respective one of the ports 206 can have a separate interface controller coupled thereto.

The system controller 202 can include direct memory access (DMA) components that can allow for the system controller 202 to access main memory of a computing system (e.g., DRAM, SRAM, etc. of the host systems 104 of the computing system 100 illustrated by FIG. 1). Write DMA 207 and read DMA 209 can facilitate transfer of information between the host systems and the memory devices of the storage system. In at least one embodiment, the write DMA 207 facilitates reading of data from a host system and writing of data to a memory device of the storage system. In at least one embodiment, the read DMA 209 can facilitate reading of data from a memory device of a storage system and writing of data to a host system. In some embodiments, the write DMA 207 and/or read DMA 209 reads and writes data via a PCIe connection.

The system controller 202 can include a completion management component 213. The completion management component 213 can be analogous to the completion management component 113 illustrated by FIG. 1. The functionality of the completion management component 213 can be implemented by the system controller 202 and/or one or more components (e.g., the interface controller 208, the memory controller 214, the write DMA 207, and/or the read DMA 209) within the system controller 202.

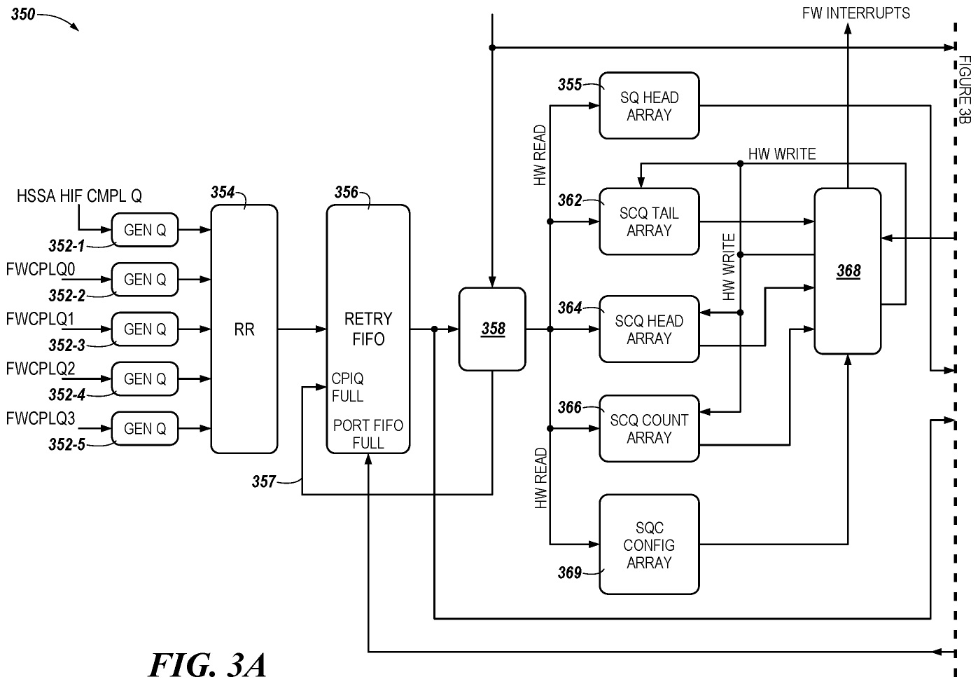

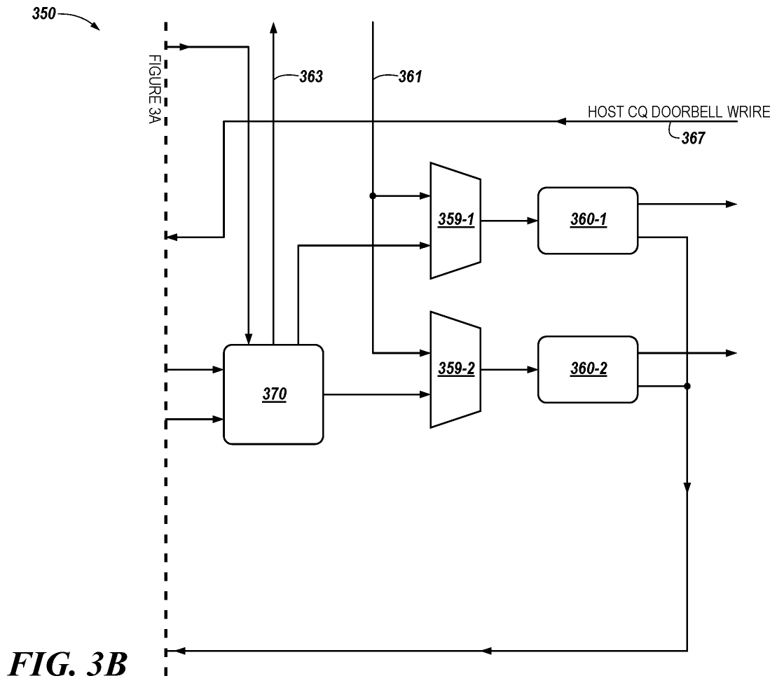

FIGS. 3A-3B illustrate an example of a firmware interface 350 in accordance with some embodiments of the present disclosure. The firmware interface 350 can be a component of the storage system 116 illustrated by FIG. 1. For example, the firmware interface 350 can be a component of the system controller 102. The firmware interface 350 can be based on configuration of completion queues of a host, such as the host 102 illustrated by FIG. 1. The firmware interface 350 can be modified in response to a host update of doorbell registers. The firmware interface 350 can facilitate communication of data packets from the storage system 116 to one or more of the host systems 104. The firmware interface 350 can include one or more completion sources (GenQ) 352-1, 352-2, 352-3, 352-4, and 352-5 (referred to collectively as completion sources 352). The completion sources 352 can correspond to respective functions of At least one of the completion sources 352 (e.g., completion source 352-31) can be associated with a Host Subsystem Automation (HSSA) block of a storage system to which the firmware interface 350 is coupled, such as the storage system 110 illustrated by FIG. 1. At least one of the completion sources 352 (e.g., completion sources 352-2, 352-3, 352-4, and 352-5) can be associated with firmware of the storage system. The completion sources 352 can be coupled to a retry FIFO 356. The firmware interface 350 can include circuitry 354 configured to transfer completions from the completion sources 352 in a round robin manner.

The firmware interface 350 can include submission queues 360-1 and 360-2 (commonly referred to as the submission queues 360). The submission queue 360-1 can be associated with a first port of the firmware interface 350 (e.g., the port 106-1). The first port can be associated with a first function of the storage system. The submission queue 360-2 can be associated with a second port of the firmware interface 350 (e.g., the port 106-N). The second port can be associated with a second function of the storage system. Each of the submission queues 360 can be coupled to a respective multiplexer. For example, a multiplexer 359-1 can be coupled to the submission queue 360-1 and a multiplexer 359-2 can be coupled to the submission queue 360-2. Although FIGS. 3A-3B illustrate two submission queues and multiplexers, embodiments of the present disclosure are not so limited. For example, the firmware interface 350 can include fewer or greater than two submission queues and multiplexers.

The firmware interface 350 include a lookup circuitry 358 coupled to the retry FIFO 356 and configured to determine whether a completion queue of a host, such as the host 102, to which a completion is to be communicated is full. As described herein, a head pointer and a tail pointer can be used to determine whether the completion queue is full. The firmware interface 350 can include a register 362 (SCQ Tail Array) configured to store data values indicative of a tail pointer associated with the completion queue and a register 364 (SCQ Head Array) configured to store data values indicative of a head pointer associated with the completion queue. The firmware interface 350 can include a register 366 (SCQ Count Array) configured to store data values indicative of a count of completions stored in the completion queue. The firmware interface 350 can include circuitry 368 coupled to the registers 362, 364, and 366 and configured to update the tail pointer, the head pointer, and the count associated with the completion queue. The circuitry 368 can be configured to update the tail pointer, the head pointer, and the count associated with the completion queue in response a doorbell signal 367 from the completion queue (Host CQ Doorbell Write). The circuitry 368 can be configured to perform a hardware write to the registers 362, 364, and 366 to update the tail pointer, the head pointer, and the count associated with the completion queue, respectively. The circuitry 368 can be configured to issue firmware interrupts. The lookup circuitry 358 can be configured to perform hardware reads of the registers 362, 364, and 366 to determine whether the completion queue is full. The lookup circuitry 358 can be configured to provide a signal 357 indicative of whether the completion queue being full (CplQ Full) to the retry FIFO 356. The firmware interface 350 can include a register 369 (SCQ Config Array) configured to store data indicative of a configuration of the retry FIFO 356 (e.g., an order in which completions were received by the retry FIFO 356, an order in which to attempt communication of completions from the retry FIFO 356). The firmware interface 350 can include a register 355 configured to store data values indicative of a head pointer associated with the submission queues 360.

In response to the signal 357 being indicative of the completion queue being full, the completion can remain in the retry FIFO 356. However, the completion can be moved to a different allocation of the retry FIFO 356. In response to the signal 357 being indicative of the completion queue not being full, the retry FIFO 356 can be configured to transfer completions to TLP generation circuitry 370. The TLP generation circuitry 370 can be configured to transfer a completion TLP to the submission queues 360.

Each of the submission queues 360 can be coupled to a respective multiplexer. For example, a multiplexer 359-1 can be coupled to the submission queue 360-1 and a multiplexer 359-2 can be coupled to the submission queue 360-2. The TLP generation circuitry 370 can be configured, via a communication path 363, to cause a signal 361 to be provided to the multiplexer 359-1 and/or the multiplexer 359-2 to enable a completion TLP to be transferred from the TLP generation circuitry 370 to the submission queue 360-1 and/or the submission queue 360-2.

The retry FIFO 356 can include logic to cycle through the completions pending in the retry FIFO 356 when the doorbell signal 367 is received to prevent head-of-line blocking that can occur if only the head entry in the retry FIFO 356 is processed. In at least one embodiment, the submission queues 360 can be configured to transfer a completion back to the retry FIFO 356 in response to a corresponding one of the submission queues 360 being full (e.g., signal 365 (Port FIFOs full)).

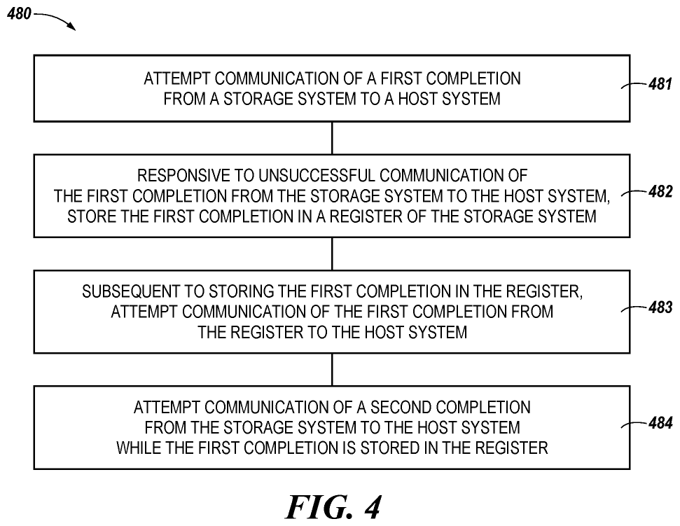

FIG. 4 is a flow diagram corresponding to a method 480 for performing completion management in accordance with some embodiments of the present disclosure. The method 480 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, each method 480 is performed using the completion management component 113 of FIG. 1, and/or the completion management component 213 of FIG. 2. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 481, the method 480 can include attempting communication of a first completion from a storage system (such as the storage system 116 illustrated by FIG. 1) to a host system (such as the host system 104-1). At operation 482, the method 480 can include storing the first completion in a register of the storage system in response to an unsuccessful communication of the first completion from the storage system to the host system. At operation 483, the method 480 can include subsequent to storing the first completion in the register, attempting communication of the first completion from the register to the host system. At operation 484, the method 480 can include attempting communication of a second completion from the storage system to the host system while the first completion is stored in the register.

In some embodiments, the method 480 can include, in response to unsuccessful communication of the second completion from the storage system to the host system, storing the second completion in the register. The method 480 can include attempting communication of the second completion from the register to the host system while the first completion is stored in the register. The first completion can be associated with a first transaction processed by the storage system and the second completion is associated with a second transaction processed by the storage system subsequent to the first transaction. The method 480 can include attempting communication of the second completion from the register to the host system subsequent to attempting communication of the first completion from the register to the host system.

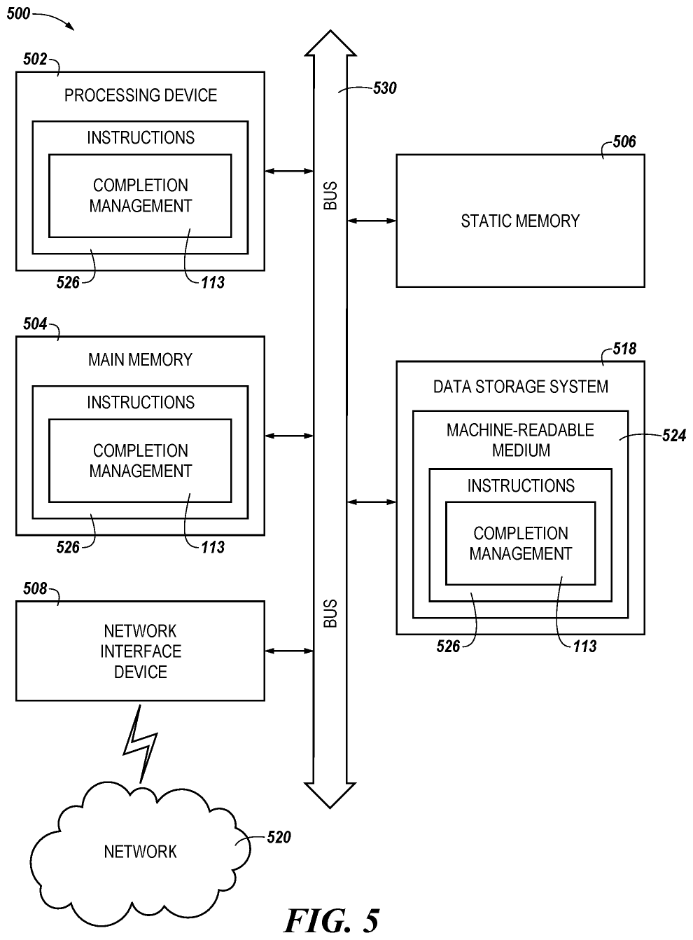

FIG. 5 illustrates an example machine of a computer system 500 within which a set of instructions, for causing the machine to perform any one or more of the methodologies discussed herein, can be executed. In some embodiments, the computer system 600 can correspond to a host system (e.g., the host system 104-1 of FIG. 1) that includes, is coupled to, or utilizes a storage system (e.g., the storage system 116 of FIG. 1) or can be used to perform the operations of a controller (e.g., to execute an operating system to perform operations corresponding to the completion management component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage system 518, which communicate with each other via a bus 530.

The processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the storage system 116 of FIG. 1.

In one embodiment, the instructions 526 include instructions to implement functionality corresponding to a memory interface (e.g., the completion management component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a storage system; and
circuitry coupled to the storage system and configured to perform operations comprising:
attempting to communicate a first completion associated with a first transaction processed by the storage system to a component external to the storage system; and
responsive to failure to communicate the first completion:
storing the first completion in a local memory of the storage system; and
subsequently attempting to communicate the first completion from the local memory to the component external to the storage system.

2. The system of claim 1, wherein the circuitry is to perform operations comprising:
responsive to failure to communicate the first completion from the local memory to the component external to the storage system:
transferring the first completion to the local memory of the storage system; and
subsequently attempting another communication of the first completion from the local memory to the component external to the storage system.

3. The system of claim 1, wherein the circuitry is to perform operations comprising:
attempting to communicate a second completion associated with a second transaction processed by the storage system to the component external to the storage system or another component external to the storage system; and
responsive to failure to communicate the second completion to the component external to the storage system or the other component external to the storage system:
storing the second completion in the local memory of the storage system; and
subsequently attempting to communicate the second completion from the local memory to the component external to the storage system or the other component external to the storage system.

4. The system of claim 3, wherein the circuitry is to perform operations comprising:
maintaining an order of processing of the first transaction and the second transaction; and
attempting to communicate the first completion and the second completion from the local memory according to the order.

5. The system of claim 4, wherein the first transaction is processed by the storage system prior to the second transaction, and
wherein the circuitry is to attempt to communicate the first completion from the local memory to the component external to the storage system prior to attempting to communicate the second completion from the local memory to the component external to the storage system or the other component external to the storage system.

6. A method, comprising:
attempting communication of a first completion from a storage system to a host system;
responsive to an unsuccessful communication of the first completion from the storage system to the host system, storing the first completion in a register of the storage system;
subsequent to storing the first completion in the register, attempting communication of the first completion from the register to the host system; and
attempting communication of a second completion from the storage system to the host system while the first completion is stored in the register.

7. The method of claim 6, further comprising:
responsive to an unsuccessful communication of the second completion from the storage system to the host system, storing the second completion in the register of the storage system; and
attempting communication of the second completion from the register to the host system while the first completion is stored in the register.

8. The method of claim 7, wherein the first completion is associated with a first transaction processed by the storage system,
wherein the second completion is associated with a second transaction processed by the storage system subsequent to the first transaction, and
wherein the method further comprises attempting communication of the second completion from the register to the host system subsequent to attempting communication of the first completion from the register to the host system.

9. A system, comprising:
a storage system comprising a completion management component configured to perform operations comprising:
determining whether an initial communication of a completion, associated with a transaction processed by the storage system, from the storage system to a host system is successful;
responsive to determining that the initial communication of the completion was unsuccessful, storing the completion in a register of the storage system; and
attempting to communicate the completion from the register to the host system.

10. The system of claim 9, further comprising the host system coupled to the storage system, and
wherein the register is a first in, first out (FIFO) register.

11. The system of claim 9, wherein the completion management component is to determine whether the initial communication of the completion is successful without interaction of firmware of the storage system.

12. The system of claim 9, wherein the completion management component is to attempt communication of the completion from the register to the host system without interaction of firmware of the storage system.

13. The system of claim 9, wherein the completion management component is to attempt communication of the completion from the register to the host system in a round robin manner.

14. A system, comprising:
a storage system comprising a plurality of submission queues and hardware logic circuitry; and
a host system coupled to the storage system and comprising a completion queue,
wherein the hardware logic circuitry is configured to perform operations comprising:
retrieving a first completion from a first one of the plurality of submission queues;
performing a first determination whether the completion queue is full; and
responsive to the first determination being that the completion queue is full, storing the first completion in a register of the storage system.

15. The system of claim 14, wherein a storage capacity of the register corresponds to a storage capacity of the completion queue, and
wherein the hardware logic circuitry is to determine whether the completion queue is full by being configured to perform operations comprising:
maintaining a head pointer and a tail pointer of completions stored in the plurality of submission queues;
updating the tail pointer in response to a completion being transferred to any one of the plurality of submission queues; and
determining that the completion queue is full in response to a value of the tail pointer being at least the storage capacity of the register.

16. The system of claim 14, wherein the hardware logic circuitry is configured to perform operations comprising:
subsequent to storing the first completion in the register of the storage system, performing a second determination whether the submission queue is full; and
responsive to the second determination being that the submission queue is not full, transferring the first completion from the register to the completion queue.

17. The system of claim 16, wherein the hardware logic circuitry is to, responsive to the second determination being that the completion queue is full, storing the first completion in the register of the storage system.

18. The system of claim 16, wherein the hardware logic circuitry is to retrieve the first completion from the first one of the plurality of submission queues in response to signaling indicative of the first completion transferred to the first one of the plurality of submission queues.

19. The system of claim 14, wherein the hardware logic circuitry is configured to perform operations comprising:
retrieving a second completion from a second one of the plurality of completion queues;
performing a second determination whether the submission queue is full;
responsive to the second determination being that the completion queue is full, storing the second completion in the register of the storage system; and
responsive to the second determination being that the completion queue is not full, transferring the second completion from the register to the completion queue.

20. The system of claim 14, wherein the hardware logic circuitry is to retrieve the first completion from the first one of the plurality of submission queues in response to first doorbell signal.
